(19) United States
(12) Patent Application Publication
(10) Pub. No.: US 2016/0314214 A1
(43) Pub. Date: Oct. 27, 2016

(54) INFORMATION RETRIEVAL METHOD, APPARATUS AND SYSTEM

(71) Applicant: TENCENT TECHNOLOGY (SHENZHEN) COMPANY LIMITED, Shenzhen, Guangdong (CN)

(72) Inventors: CHENGJUN LI, Shenzhen (CN); XIAOPENG SONG, Shenzhen (CN); YINGXUE LIU, Shenzhen (CN); QIAN HUA, Shenzhen (CN); KEXIN SONG, Shenzhen (CN); JUNYI CAI, Shenzhen (CN); XIA WU, Shenzhen (CN)

(21) Appl. No.: 15/104,483

(22) PCT Filed: Jan. 20, 2015
(86) PCT No.: PCT/CN15/71106

§ 371 Date: Jun. 14, 2016

(30) Foreign Application Priority Data
Jan. 22, 2014 (CN) 2014-10030591.7

(51) Int. Cl. G06F 17/30; H04L 29/06; G06Q 40/04

(52) U.S. Cl. CPC G06F 17/30867; G06Q 40/04; G06F 17/30277; H04L 67/42

(57) ABSTRACT

The present disclosure discloses an information retrieval method, apparatus and system, which belong to the field of information processing. The method includes: receiving a retrieval line which is input in a graphic manner; detecting whether an information model matching with the retrieval line exists, each information model corresponding to an information model identifier; sending, if a detection result is that an information model matching with the retrieval line exists, an information model identifier of the information model to a server; and receiving at least one piece of information fed back by the server, the information being fed back after the server identifies a corresponding information model according to the information model identifier and then retrieves at least one piece of information matched with the information model according to the information model, and therefore the problems that a user needs to set condition parameters to construct an information model and the operation is complex are solved; the effects that a user can find information needed by the user without the need to set condition parameters to construct an information model, the operation complexity is reduced and the user does not need to have a good capability of constructing an information model are achieved.

### RELATED APPLICATION

This application claims priority to PCT Application No. PCT/CN2015/071106, filed on Jan. 20, 2015, which claims priority to Chinese Patent Application No. 2014100305917, entitled “Information retrieval method, apparatus and system” filed on Jan. 22, 2014. The applications are incorporated by reference in their entirety.

### FIELD OF THE TECHNOLOGY

The present disclosure relates to the field of information processing, and in particular to an information retrieval method, apparatus and system.

### BACKGROUND OF THE DISCLOSURE

With rapid popularization of mobile terminals, more and more people are fond of performing information retrieval by using mobile terminals such as a mobile phone and a tablet computer, such as retrieving an expected type of stock information by using a mobile phone.

Currently, when a mobile terminal selects a stock, a method similar to that for a PC client device is used, that is, during stock-picking, a user sets multiple condition parameters on the mobile terminal by using an input box or a pull-down setting box, and the mobile terminal sends the condition parameters set by the user to a server. The server constructs a stock model according to the condition parameters set by the user, and feeds back at least one piece of stock information matched with the stock model to the mobile terminal, and the mobile terminal presents the at least one piece of stock information to the user.

During implementation of the present disclosure, the foregoing method requires a user to set condition parameters to construct a stock model, but because the construction of a stock model requires the user to have in-depth knowledge and understanding of stocks, it is difficult for an ordinary user only having superficial understanding of stocks to complete the operation. For example, if a user needs to select a stock whose stock trend line belongs to a “head-and-shoulders bottom” type, where the trend line of the stock of the “head-and-shoulders bottom” type is formed by a left shoulder line, a bottom line, a right shoulder line and a neck line, a stock of the type requires the user to set 6 different condition parameters to construct a stock model of the stock of the type, which not only requires the user to have in-dpeth knowledge and understanding of stocks but also incurs a complex operation process.

### SUMMARY

The above deficiencies and other problems associated with the conventional approach of information retrieval are reduced or eliminated by the invention disclosed below. In some embodiments, it requires a user to set condition parameters to construct an information model, and the operation is complex, embodiments of the present invention provide an information retrieval method, apparatus and system. The technical solutions are as follows:

According to one aspect, an information retrieval method applied to a client device having one or more processors and a memory for storing instructions executed by the one or more processors is provided. The method includes receiving a retrieval line which is input in a graphic manner; detecting whether an information model matching with the retrieval line exists, each information model corresponding to an information model identifier; sending, if a detection result is that an information model matching with the retrieval line exists, an information model identifier of the information model to a server; and receiving at least one piece of information fed back by the server, the information being fed back after the server identifies a corresponding information model according to the information model identifier and then retrieves at least one piece of information matched with the information model according to the information model.

According to another aspect, an information retrieval method applied to a server having one or more processors and a memory for storing instructions executed by the one or more processors is provided, the method including: receiving an information model identifier sent by a client device, the information model identifier being sent by the client device when receiving a retrieval line which is input in a graphic manner, and then detecting that an information model matching with the retrieval line exists; identifying a corresponding information model according to the information model identifier; retrieving at least one piece of information matched with the information model according to the information model; and feeding back the at least one piece of information to the client device.

According to another aspect, an information retrieval apparatus is provided, including: one or more processors; and a memory, where one or more program modules are stored in the memory and executed by the one or more processors, and the one or more program modules include: a line receiving module, configured to receive a retrieval line which is input in a graphic manner; a line detecting module, configured to detect whether an information model matching with the retrieval line exists, each information model corresponding to an information model identifier; an identifier sending module, configured to send, if a detection result is that an information model matching with the retrieval line exists, an information model identifier of the information model to a server; and an information receiving module, configured to receive at least one piece of information fed back by the server, the information being fed back after the server identifies a corresponding information model according to the information model identifier and then retrieves at least one piece of information matched with the information model according to the information model.

According to yet another aspect, an information retrieval apparatus is provided, including: one or more processors; and a memory, where one or more program modules are stored in the memory and executed by the one or more processors, and the one or more program modules include: an identifier receiving module, configured to receive an information model identifier sent by a client device, where the information model identifier is sent by the client device when receiving a retrieval line which is input in a graphic manner, and then detecting that an information model matching with the retrieval line exists; a model search module, configured to identify a corresponding information model according to the information model identifier; an information retrieval module, configured to retrieve at least one piece of information matched with the information model according to the information model; and an information feedback module, configured to feed back the at least one piece of information to the client device.

According to yet another aspect, an information retrieval system is provided, where the system includes at least one client device and a server, and the at least one client device is connected to the server by using a wired network or wireless network; the client device includes the information retrieval apparatus the foregoing third aspect; and the server includes the information retrieval apparatus the foregoing fourth aspect.

By receiving a retrieval line which is input in a graphic manner; detecting whether an information model matching with the retrieval line exists, each information model corresponding to an information model identifier; sending, if a detection result is that an information model matching with the retrieval line exists, an information model identifier of the information model to a server; and receiving at least one piece of information fed back by the server, the information being fed back after the server identifies a corresponding information model according to the information model identifier and then retrieves at least one piece of information matched with the information model according to the information model, the problems that a user needs to set condition parameters to construct an information model and the operation is complex are solved; the effects that a user can find information needed by the user without the need to set condition parameters to construct an information model, the operation complexity is reduced and the user does not need to have a good capability of constructing an information model are achieved.

### BRIEF DESCRIPTION OF THE DRAWINGS

To describe the technical solutions of the embodiments of the present invention more clearly, the accompanying drawings for illustrating the embodiments will be introduced briefly in the following. Apparently, the drawings in the following description are only some embodiments of the present invention, and a person of ordinary skill in the art may obtain other drawings based on these accompanying drawings without creative efforts.

FIG. 1 is a schematic structural diagram of an implementation environment related to an information retrieval method according to an embodiment of the present invention;

FIG. 2 is a method flowchart of an information retrieval method according to an embodiment of the present invention;

FIG. 3 is a method flowchart of an information retrieval method according to another embodiment of the present invention;

FIG. 4A is a method flowchart of an information retrieval method according to another embodiment of the present invention;

FIG. 4B is a schematic diagram of inputting a retrieval line according to another embodiment of the present invention;

FIG. 4C is a schematic diagram of drawing a line to pick a stock according to another embodiment of the present invention;

FIG. 4D is a schematic diagram of a stock trend line according to another embodiment of the present invention;

FIG. 5 is a structure block diagram of an information retrieval apparatus according to an embodiment of the present invention;

FIG. 6 is a structure block diagram of an information retrieval apparatus according to another embodiment of the present invention;

FIG. 7 is a structure block diagram of an information retrieval apparatus according to another embodiment of the present invention;

FIG. 8 is a schematic structural diagram of a terminal according to an embodiment of the present invention; and

FIG. 9 is a schematic structural diagram of a server according to an embodiment of the present invention.

### DESCRIPTION OF EMBODIMENTS

To make the objectives, technical solutions, and advantages of the present disclosure more comprehensible, the following further describes the embodiments of the present invention in detail with reference to the accompanying drawings.

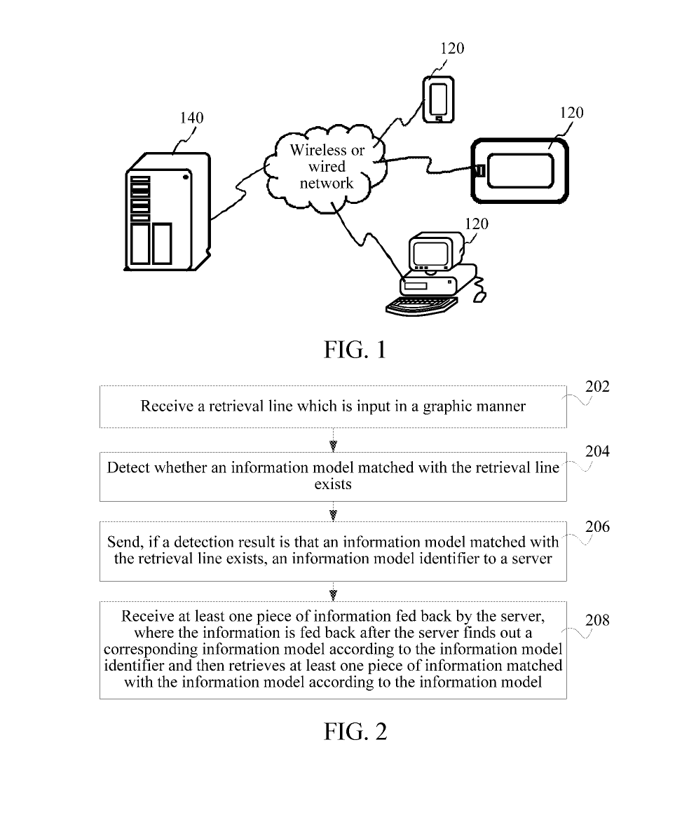

FIG. 1 is a schematic structural diagram of an implementation environment related to an information retrieval method according to each embodiment of the present invention. The implementation environment includes at least one terminal 120 and a server 140.

The terminal 120 may be a smart phone, a tablet computer, an intelligent television, an e-book reader, an MP3 player (Moving Picture Experts Group Audio Layer III), an MP4 (Moving Picture Experts Group Audio Layer IV) player, a laptop portable computer, a desktop computer and the like. The terminal 120 is connected to the server 140 by using a wired network or wireless network.

The server 140 may be one server, a server cluster formed by several servers, or a cloud computing service center. The server 140 may provide an information retrieval service to a client device installed in the terminal 120, and information in this embodiment of the present invention is generally data information which can be represented by using a curve, such as stock information, weather information and other information about a trend curve on which statistics is collected according to time. Preset information models and identifiers one-to-one corresponding to the information models are stored in the server 140. For example, if the information model is a stock model, the stock model and the name of the stock model are stored in the server.

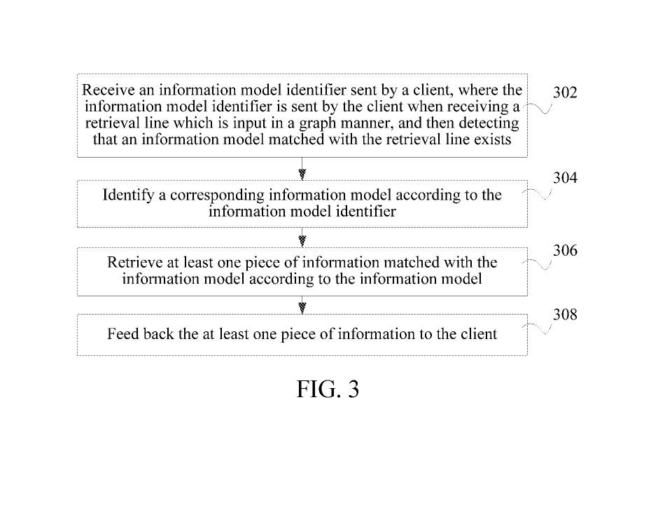

FIG. 2 is a method flowchart of an information retrieval method according to an embodiment of the present invention. This embodiment is described by using that the information retrieval method is applied to the client device having one or more processors and a memory for storing instructions executed by the one or more processors shown in FIG. 1 as an example. The information retrieval method includes the following steps:

Step 202: Receive a retrieval line which is input in a graphic manner.

Step 204: Detect whether an information model matching with the retrieval line exists, each information model corresponding to an information model identifier.

Step 206: Send, if a detection result is that an information model matching with the retrieval line exists, an information model identifier of the information model to a server.

Step 208: Receive at least one piece of information fed back by the server, the information being fed back after the server identifies a corresponding information model according to the information model identifier and then retrieves at least one piece of information matched with the information model according to the information model.

Information in this embodiment of the present invention may be data information which can be represented by using a curve, such as stock information, weather information and other information about a trend curve on which statistics is collected according to time. A representational curve of information obtained by performing matching by using an information model and a retrieval line corresponding to the information model has similar fluctuating characteristics.

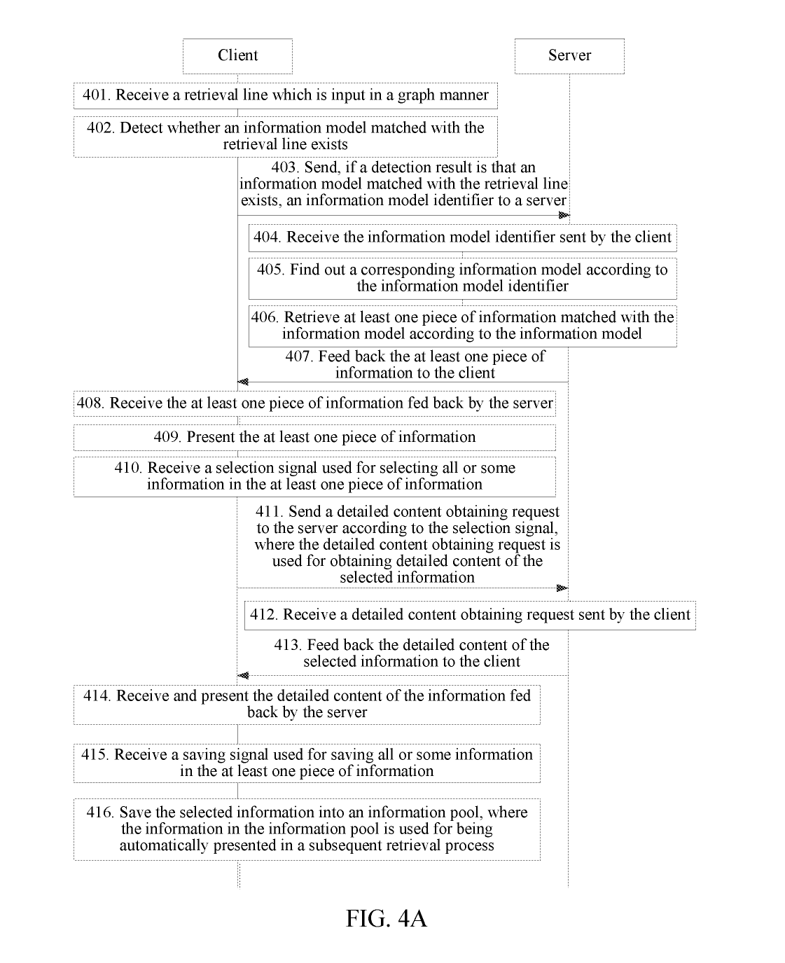

FIG. 3 is a method flowchart of an information retrieval method according to an embodiment of the present invention. This embodiment is described by using that the information retrieval method is applied to the server having one or more processors and a memory for storing instructions executed by the one or more processors shown in FIG. 1 as an example. The information retrieval method includes the following steps.

Step 302: Receive an information model identifier sent by a client device, where the information model identifier is sent by the client device when receiving a retrieval line which is input in a graphic manner, and then detecting that an information model matching with the retrieval line exists.

Step 304: Identiy a corresponding information model according to the information model identifier.

Step 306: Retrieve at least one piece of information matched with the information model according to the information model.

Information in this embodiment of the present invention may be data information which can be represented by using a curve, such as stock information, weather information and other information about a trend curve on which statistics is collected according to time. A representational curve of information obtained by performing matching by using an information model and a retrieval line corresponding to the information model has similar fluctuating characteristics.

Step 308: Feedback the at least one piece of information to the client device.

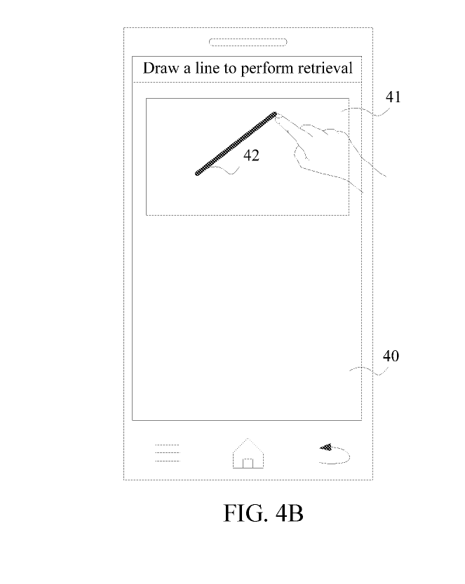

FIG. 4A is a method flowchart of an information retrieval method according to an embodiment of the present invention. This embodiment is described by using that the information retrieval method is applied to the implementation environment shown in FIG. 1 and the information is stock information as an example. The information retrieval method includes the following steps:

Step 401: A client device receives a retrieval line which is input in a graphic manner.

The retrieval line may be a line segment, a curve or a broken line, and may also be a line formed by a combination of any two or three of a line segment, a curve and a broken line. The retrieval line is input by a user to the client device in a graphic manner, and correspondingly, the client device receives the retrieval line which is input in the graphic manner.

This step has the following two types of implementation manners.

First type: The client device receives a retrieval line which is input by means of a slide touch signal.

If the terminal in which the client device is installed is a touch screen terminal, the user may input a retrieval line in a slide touch manner, and correspondingly, the client device receives the retrieval line which is input by means of a slide touch signal. As shown in FIG. 4B, the user slides and touches, in a touch display screen 40, an area where a retrieval input box 41 is located, and a track of the slide and touch forms a retrieval line 42.

Second type: The client device receives a retrieval line which is input by means of a mouse drag signal.

If the terminal in which the client device is installed is an electronic device having a mouse, the user may input a retrieval line in a manner of dragging the mouse to form a drag signal, and correspondingly, the client device receives the retrieval line which is input by means of a mouse drag signal.

Step 402: The client device detects whether an information model matching with the retrieval line exists, each information model corresponding to an information model identifier.

The client device searches for an information model matching with a line characteristic of the retrieval line according to the line characteristic of the retrieval line. For example, as shown in Table 1, assuming that the information model is a stock model, the information model includes: a horizontal-price-movement and stock-picking model, a short-term trend rising model, a volatile and rising model, an intermediate-term trend rising model, a horizontal-price-movement and breakthrough model, a horizontal-price-movement and breakthrough adjustment model, a rising retraction model, a rising retraction breakthrough model, a rising horizontal-price-movement and consolidation model, a head-and-shoulders bottom model, a double-bottom model, a triple-bottom model, a V-shaped reversal model, an arc bottom model, a triangular consolidation model and a wedge consolidation model.

TABLE 1

| | Schematic | |
|---|---|---|
| | diagram of | |
| Name of stock model | retrieval line | Retrieval line corresponding to stock model |
| Horizontal-price-movement and | [symbol] | Line along a horizontal direction; |
| stock-picking | | |
| Short-term trend rising | [symbol] | Line which extends and is formed from bottom |
| | | left to top right and the length of which is less |
| | | than a predetermined threshold; |
| Volatile and rising | [symbol] | Line ascending and formed zigzag from bottom |
| | | left to top right; |
| Intermediate-term trend rising | [symbol] | Line which extends and is formed from bottom |
| | | left to top right and the length of which is |
| | | greater than the predetermined threshold; |
| Horizontal-price-movement and | [symbol] | First line along the horizontal direction and |
| breakthrough | | second line extending and formed from a right |
| | | endpoint of the first line to top right; |
| Horizontal-price-movement and | [symbol] | Third line along the horizontal direction, fourth |
| breakthrough adjustment | | line extending and formed from a right endpoint |
| | | of the third line to top right and fifth line |
| | | extending and formed from a right endpoint of |
| | | the fourth line to bottom right; |
| Rising retraction | [symbol] | Sixth line extending and formed from bottom |
| | | left to top right and seventh line extending and |
| | | formed from a right endpoint of the sixth line to |
| | | bottom right; |
| Rising retraction breakthrough | [symbol] | Eighth line extending and formed from bottom |
| | | left to top right, ninth line extending and formed |
| | | from a right endpoint of the eighth line to |
| | | bottom right and tenth line extending and |
| | | formed from a right endpoint of the ninth line to |
| | | top right; |
| Rising horizontal-price- | [symbol] | Eleventh line extending and formed from |
| movement and consolidation | | bottom left to top right and twelfth line formed |
| | | along the horizontal direction from a right |
| | | endpoint of the eleventh line; |
| Head-and-shoulders bottom | [symbol] | Thirteenth line extending and formed from top |
| | | left to bottom right, fourteenth line extending |
| | | and formed from a right endpoint of the |
| | | thirteenth line to top right, fifteenth line |
| | | extending and formed from a right endpoint of |
| | | the fourteenth line to bottom right, sixteenth |
| | | line extends forming from a right endpoint of |
| | | the fifteenth line to top right, seventeenth line |
| | | extending and formed from a right endpoint of |
| | | the sixteenth line to bottom right and eighteenth |
| | | line extending and formed from a right endpoint |
| | | of the seventeenth line to top right, where the |
| | | right endpoint of the fifteenth line is lower than |
| | | the right endpoint of the thirteenth line and |
| | | lower than the right endpoint of the seventeenth |
| | | line; |
| Double-bottom | [symbol] | Nineteenth line extending and formed from top |
| | | left to bottom right, twentieth line extending |
| | | and formed from a right endpoint of the |
| | | nineteenth line to top right, twenty first line |
| | | extending and formed from a right endpoint of |
| | | the twentieth line to bottom right and twenty |
| | | second line extending and formed from a right |
| | | endpoint of the twenty first line to top right; |
| Triple-bottom | [symbol] | Twenty third line extending and formed from |
| | | top left to bottom right, twenty fourth line |
| | | extending and formed from a right endpoint of |
| | | the twenty third line to top right, twenty fifth |
| | | line extending and formed from a right endpoint |
| | | of the twenty fourth line to bottom right, twenty |
| | | sixth line extending and formed from a right |
| | | endpoint of the twenty fifth line to top right, |
| | | twenty seventh line extending and formed from |
| | | a right endpoint of the twenty sixth line to |
| | | bottom right and twenty eighth line extending |
| | | and formed from a right endpoint of the twenty |
| | | seventh line to top right; |
| V-shaped reversal | [symbol] | Twenty ninth line extending and formed from |
| | | top left to bottom right and thirtieth line |
| | | extending and formed from a right endpoint of |
| | | the twenty ninth line to top right; |
| Arc bottom | [symbol] | Curve with an upward opening; |
| Triangular consolidation | [symbol] | Thirty first line extending and formed from top |
| | | left to bottom right and thirty second line |
| | | extending and formed from a right endpoint of |
| | | the thirty first line to left below; |
| Wedge consolidation | [symbol] | Line including two lines, slant directions of |
| | | which are the same and which are not parallel. |

It should be noted that, preset information models are saved in a server, only each information model identifier is saved in the client device, and the client device can determine, according to a retrieval line, an information model identifier corresponding to the retrieval line.

Step 403: The client device sends, if a detection result is that an information model matching with the retrieval line exists, an information model identifier of the information model to a server.

The information model identifier, such as, an information model name and an information model digital code, is used for uniquely identifying the information model. Assuming that the information model is a stock model, the information model identifier may be a stock model name, such as, volatile and rising, head-and-shoulders bottom and double-bottom.

After detecting that an information model matching with the retrieval line exists, client device finds out an information model identifier, and sends the information model identifier to the server.

Additionally, the client device further may present the information model identifier on the display screen of the terminal, so that the user learns the identifier of the information model, of the preset information models, corresponding to the retrieval line which is currently input by the user in a graphic manner.

It should be additionally noted that if the detection result is that no information model matching with the retrieval line exists, that is, no information model matched with at least one line characteristic of the retrieval line exists in the preset information models. In this case, no information model matched with at least one line characteristic of the retrieval line may exist in the preset information models. The client device reminds the user on the display screen of the terminal that no information model matching with the retrieval line is detected, and the user may choose to input a retrieval line again, or construct a stock model in an existing parameter setting manner.

Step 404: The server receives the information model identifier sent by the client device.

The server receives, by using a wireless network or wired network, an information model identifier sent by the client device, where the information model identifier is sent by the client device when receiving a retrieval line which is input in a graphic manner, and then detecting that an information model matching with the retrieval line exists.

Step 405: The server identifies a corresponding information model according to the information model identifier.

Information models one-to-one corresponding to information model identifiers are stored in the server in advance, and therefore, after receiving an information model identifier sent by the client device, the server identifies a corresponding information model according to the information model identifier.

Step 406: The server retrieves at least one piece of information matched with the information model according to the information model.

This step specifically includes the following sub-steps:

1. The server obtains at least one condition parameter corresponding to the information model.

Because information in this article generally refers to data information which can be represented by using a curve, a condition parameter is used for retrieving a retrieval condition and/or a retrieval parameter used by the data information. For example, assuming that the information model is a stock model, the condition parameter may be the turnover rate, the oscillator, the bull and bear index and the like.

2. The server retrieves, in all information, at least one piece of information matched with the at least one condition parameter.

The server retrieves, in all candidate information, at least one piece of information matched with the at least one condition parameter. A representational curve of information obtained by performing matching by using an information model and a retrieval line corresponding to the information model has similar fluctuating characteristics.

Step 407: The server feeds back the at least one piece of information to the client device.

After retrieving at least one piece of information matched with the at least one condition parameter, the server feeds back the at least one piece of information to the client device, so that the client device processes the at least one piece of information.

Step 408: The client device receives the at least one piece of information fed back by the server.

The information is fed back after the server identifies a corresponding information model according to the information model identifier and then retrieves at least one piece of information matched with the information model according to the information model.

Step 409: The client device presents the at least one piece of information.

After the client device receives the at least one piece of information fed back by the server, the client device may present, save and/or share the at least one piece of information, and in this step, that the client device presents the at least one piece of information is used as an example.

The client device presents the at least one piece of information on the screen of the terminal, so that the user further views detailed content of at least one piece of information of the at least one piece of information.

The specific step that the user further views detailed content of at least one piece of information of the at least one piece of information is as follows.

Step 410: The client device receives a selection signal used for selecting all or some information in the at least one piece of information.

The user may select a selection signal of all or some information in the at least one piece of information by means of a touch screen, sound control or key triggering, and correspondingly, the client device receives a selection signal used for selecting all or some information in the at least one piece of information.

Step 411: The client device sends a detailed content obtaining request to the server according to the selection signal, where the detailed content obtaining request is used for obtaining detailed content of the selected information.

The detailed content refers to detailed content corresponding to the at least one piece of information. For example, if a stock code of a piece of stock information is presented on a screen, detailed content refers to the stock name corresponding to the stock code, the stock transaction price, the stock Candlestick Chart, the stock issuer and the like, and may further be comments related to the stock, historical transaction records, related stocks and the like.

Step 412: The server receives a detailed content obtaining request sent by the client device.

The detailed content obtaining request is a request for obtaining, after the client device presents the at least one piece of information and receives a selection signal used for selecting all or some information in the at least one piece of information, detailed content of the selected information from the server according to the selection signal.

Step 413: The server feeds back the detailed content of the selected information to the client device.

After finding detailed content corresponding to the detailed content obtaining request, the server feeds back the detailed content of the selected information to the client device.

Step 414: The client device receives and presents the detailed content of the information fed back by the server.

The client device may present the detailed content of the information on the screen, so that the user reads the detailed content of the information.

After the client device receives the at least one piece of information fed back by the server, the client device may present, save and/or share the at least one piece of information, and that the client device saves the at least one piece of information is used as an example below, which is specifically as follows:

Step 415: The client device receives a saving signal used for saving all or some information in the at least one piece of information.

The user may choose to save all or some information in the at least one piece of information, and after the user triggers the saving signal used for saving all or some information in the at least one piece of information, the client device correspondingly receives the saving signal used for saving all or some information in the at least one piece of information.

Step 416: The client device saves the selected information into an information pool, where the information in the information pool is used for being automatically presented in a subsequent retrieval process.

The information pool can be used for saving the selected information, the information in the information pool is used for being automatically presented in a subsequent retrieval process, and the user can further search for a retrieval record by using the information pool. If information needed by the user is saved in the information pool, the user does not need to input any retrieval line, the client device and the server do not need to perform a series of matching and retrieval procedures either, and the user may directly select the needed information in the information pool.

In a specific embodiment, assuming that the client device is a stock application client device, the retrieval line is a stock trend line and the information model is a stock model, according to all or some of the foregoing implementation steps, this specific embodiment has the following steps.

1. As shown in FIG. 4C, the user first draws a horizontal line to the right on the touch screen by sliding the touch screen and then draws a straight line diagonally upward to form a trend line d1.

2. The stock application client device receives the foregoing trend line d1.

3. If the stock application client device detects that an information model matched with the trend line d1 is a “horizontal-price-movement and breakthrough” model, “horizontal-price-movement and breakthrough” d2 is displayed on the screen.

4. When the Internet connection speed is fast or the information retrieval performance is good, a stock list d3 occurs below the screen when the user ends line drawing on the touch screen.

The stock list is of stocks matched with the foregoing “horizontal-price-movement and breakthrough” model. FIG. 4D is a trend diagram of a “horizontal-price-movement and breakthrough” stock.

5. The user may click any stock in the stock list d3 to view detailed information of the stock.

Apparatus embodiments of the present invention are described below, and for details thereof which are not described elaborately, reference may be made to the foregoing corresponding method embodiments.

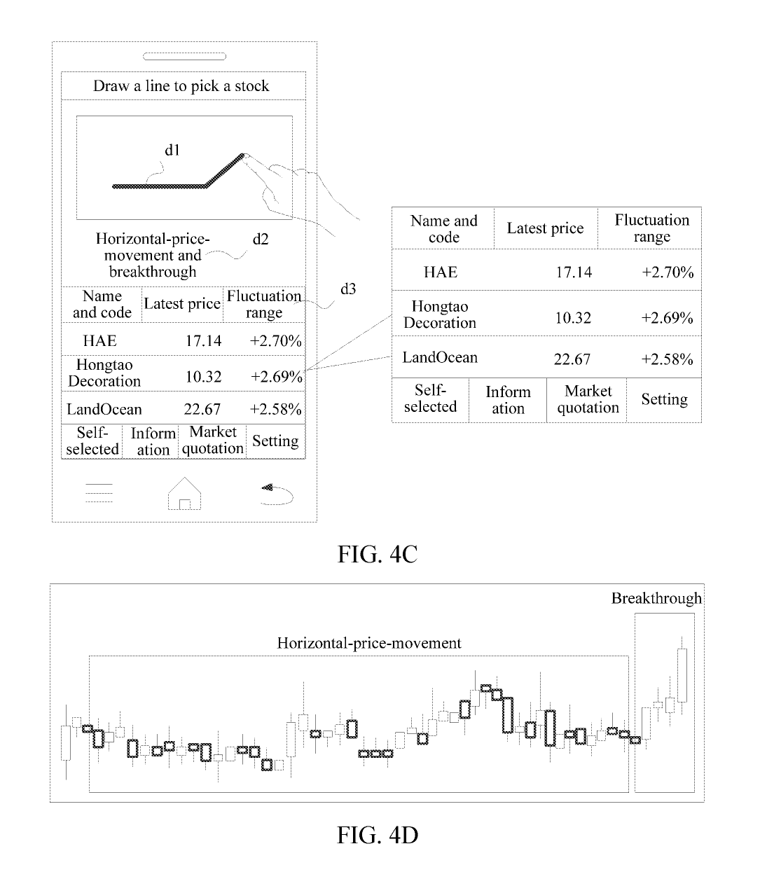

FIG. 5 is a structure block diagram of an information retrieval apparatus according to an embodiment of the present invention. The information retrieval apparatus may be implemented into all or a part of a client device by using software, hardware or a combination of the two, and the information retrieval apparatus includes: one or more processors; and a memory, where one or more program modules are stored in the memory and executed by the one or more processors, and the one or more program modules include: a line receiving module 520, a line detecting module 540, an identifier sending module 560 and an information receiving module 580.

The line receiving module 520 is configured to receive a retrieval line which is input in a graphic manner.

The line detecting module 540 is configured to detect whether an information model matching with the retrieval line received by the line receiving module 520 exists.

The identifier sending module 560 is configured to send, if a detection result detected by the line detecting module 540 is that an information model matching with the retrieval line exists, an information model identifier of the information model to a server.

The information receiving module 580 is configured to receive at least one piece of information fed back by the server, the information being fed back after the server identifies a corresponding information model according to the information model identifier and then retrieves at least one piece of information matched with the information model according to the information model.

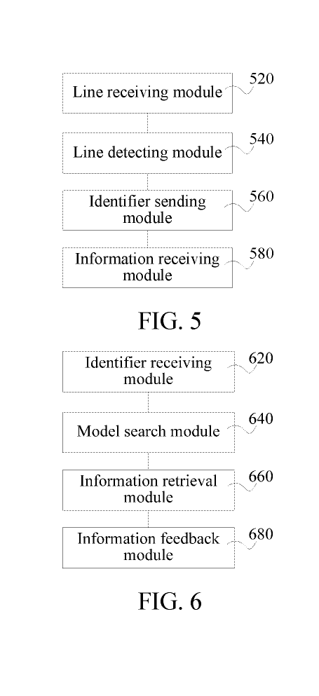

FIG. 6 is a structure block diagram of an information retrieval apparatus according to another embodiment of the present invention. The information retrieval apparatus may be implemented into all or a part of a server by using software, hardware or a combination of the two, and the information retrieval apparatus includes one or more processors; and a memory, where one or more program modules are stored in the memory and executed by the one or more processors, and the one or more program modules include: an identifier receiving module 620, a model search module 640, an information retrieval module 660 and an information feedback module 680.

The identifier receiving module 620 is configured to receive an information model identifier sent by a client device, where the information model identifier is sent by the client device when receiving a retrieval line which is input in a graphic manner, and then detecting that an information model matching with the retrieval line exists.

The model search module 640 is configured to identify a corresponding information model according to the information model identifier received by the identifier receiving module 620.

The information retrieval module 660 is configured to retrieve at least one piece of information matched with the information model according to the information model found out by the model search module 640.

The information feedback module 680 is configured to feed back the at least one piece of information retrieved by the information retrieval module 660 to the client device.

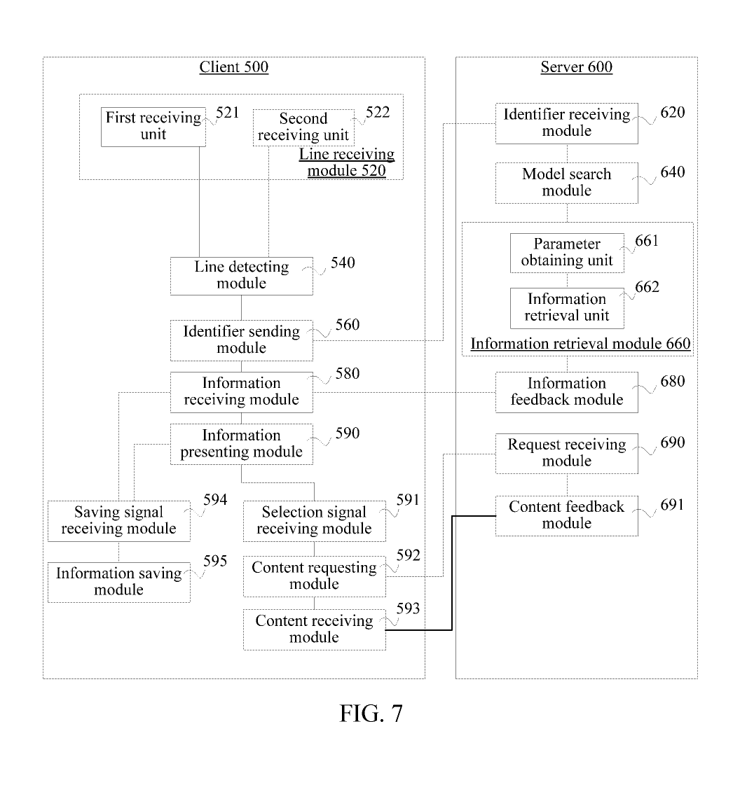

Refer to FIG. 7, which is a structure block diagram of an information retrieval system according to an embodiment of the present invention. The information retrieval system includes a client device 500 and a server 600, and the client device 500 is connected to the server 600 by using a wireless network or wired network, which is specifically as follows:

The client device 500 includes: a line receiving module 520, a line detecting module 540, an identifier sending module 560 and an information receiving module 580.

The line receiving module 520 is configured to receive a retrieval line which is input in a graphic manner.

The line detecting module 540 is configured to detect whether an information model matching with the retrieval line received by the line receiving module 520 exists.

The identifier sending module 560 is configured to send, if a detection result detected by the line detecting module 540 is that an information model matching with the retrieval line exists, an information model identifier of the information model to a server.

The information receiving module 580 is configured to receive at least one piece of information fed back by the server, the information being fed back after the server identifies a corresponding information model according to the information model identifier and then retrieves at least one piece of information matched with the information model according to the information model.

Further, the line receiving module 520 includes: a first receiving unit 521 or a second receiving unit 522. The first receiving unit 521 is configured to receive the retrieval line which is input by means of a slide touch signal. The second receiving unit 522 is configured to receive the retrieval line which is input by means of a mouse drag signal.

Further, the line detecting module 540 is configured to search for an information model matching with a line characteristic of the retrieval line according to the line characteristic of the retrieval line.

If the information is stock information, the line detecting module 540 includes the following.

A first detecting unit, configured to determine, when the retrieval line is a line along a horizontal direction, whether the information model matched with the line characteristic of the retrieval line is a horizontal-price-movement and stock-picking model;

A second detecting unit, configured to determine, when the retrieval line is a line which extends and is formed from bottom left to top right and the length of which is less than a predetermined threshold, whether the information model matched with the line characteristic of the retrieval line is a short-term trend rising model;

A third detecting unit, configured to determine, when the retrieval line is a line ascending and formed zigzag from bottom left to top right, whether the information model matched with the line characteristic of the retrieval line is a volatile and rising model;

A fourth detecting unit, configured to determine, when the retrieval line is a line which extends and is formed from bottom left to top right and the length of which is greater than the predetermined threshold, whether the information model matched with the line characteristic of the retrieval line is an intermediate-term trend rising model;

A fifth detecting unit, configured to determine, when the retrieval line is a first line along the horizontal direction and a second line extending and formed from a right endpoint of the first line to top right, whether the information model matched with the line characteristic of the retrieval line is a horizontal-price-movement and breakthrough model;

A sixth detecting unit, configured to determine, when the retrieval line is a third line along the horizontal direction, a fourth line extending and formed from a right endpoint of the third line to top right and a fifth line extending and formed from a right endpoint of the fourth line to bottom right, whether the information model matched with the line characteristic of the retrieval line is a horizontal-price-movement and breakthrough adjustment model;

A seventh detecting unit, configured to determine, when the retrieval line is a sixth line extending and formed from bottom left to top right and a seventh line extending and formed from a right endpoint of the sixth line to bottom right, whether the information model matched with the line characteristic of the retrieval line is a rising retraction model;

An eighth detecting unit, configured to determine, when the retrieval line is an eighth line extending and formed from bottom left to top right, a ninth line extending and formed from a right endpoint of the eighth line to bottom right and a tenth line extending and formed from a right endpoint of the ninth line to top right, whether the information model matched with the line characteristic of the retrieval line is a rising retraction breakthrough model;

A ninth detecting unit, configured to determine, when the retrieval line is an eleventh line extending and formed from bottom left to top right and a twelfth line formed along the horizontal direction from a right endpoint of the eleventh line, whether the information model matched with the line characteristic of the retrieval line is a rising horizontal-price-movement and consolidation model;

A tenth detecting unit, configured to determine, when the retrieval line is a thirteenth line extending and formed from top left to bottom right, a fourteenth line extending and formed from a right endpoint of the thirteenth line to top right, a fifteenth line extending and formed from a right endpoint of the fourteenth line to bottom right, a sixteenth line extends forming from a right endpoint of the fifteenth line to top right, a seventeenth line extending and formed from a right endpoint of the sixteenth line to bottom right and an eighteenth line extending and formed from a right endpoint of the seventeenth line to top right, the right endpoint of the fifteenth line is lower than the right endpoint of the thirteenth line, and the right endpoint of the fifteenth line is lower than the right endpoint of the seventeenth line, that the information model matched with the line characteristic of the retrieval line is a head-and-shoulders bottom model;

An eleventh detecting unit, configured to determine, when the retrieval line is a nineteenth line extending and formed from top left to bottom right, a twentieth line extending and formed from a right endpoint of the nineteenth line to top right, a twenty first line extending and formed from a right endpoint of the twentieth line to bottom right and a twenty second line extending and formed from a right endpoint of the twenty first line to top right, that the information model matched with the line characteristic of the retrieval line is a double-bottom model;

A twelfth detecting unit, configured to determine, when the retrieval line is a twenty third line extending and formed from top left to bottom right, a twenty fourth line extending and formed from a right endpoint of the twenty third line to top right, a twenty fifth line extending and formed from a right endpoint of the twenty fourth line to bottom right, a twenty sixth line extending and formed from a right endpoint of the twenty fifth line to top right, a twenty seventh line extending and formed from a right endpoint of the twenty sixth line to bottom right and a twenty eighth line extending and formed from a right endpoint of the twenty seventh line to top right, that the information model matched with the line characteristic of the retrieval line is a triple-bottom model;

A thirteenth detecting unit, configured to determine, when the retrieval line is a twenty ninth line extending and formed from top left to bottom right and a thirtieth line extending and formed from a right endpoint of the twenty ninth line to top right, that the information model matched with the line characteristic of the retrieval line is a V-shaped reversal model;

A fourteenth detecting unit, configured to determine, when the retrieval line is a curve with an upward opening, that the information model matched with the line characteristic of the retrieval line is an arc bottom model;

A fifteenth detecting unit, configured to determine, when the retrieval line is a thirty first line extending and formed from top left to bottom right and a thirty second line extending and formed from a right endpoint of the thirty first line to left below, that the information model matched with the line characteristic of the retrieval line is a triangular consolidation model; and

A sixteenth detecting unit, configured to determine, when the retrieval line is a line including two lines, slant directions of which are the same and which are not parallel, whether the information model matched with the line characteristic of the retrieval line is a wedge consolidation model.

Further, the client device 500 further includes: an information presenting module 590, a selection signal receiving module 591, a content requesting module 592 and a content receiving module 593.

The information presenting module 590 is configured to present the at least one piece of information.

The selection signal receiving module 591 is configured to receive a selection signal used for selecting all or some information in the at least one piece of information.

The content requesting module 592 is configured to send a detailed content obtaining request to the server according to the selection signal, where the detailed content obtaining request is used for obtaining detailed content of the selected information.

The content receiving module 593 is configured to receive and present the detailed content of the information fed back by the server.

Further, the client device 500 further includes: a saving signal receiving module 594 and an information saving module 595.

The saving signal receiving module 594 is configured to save a saving signal used for selecting all or some information in the at least one piece of information.

The information saving module 595 is configured to save the selected information into an information pool, where the information in the information pool is used for being automatically presented in a subsequent retrieval process.

The server 600 includes: an identifier receiving module 620, a model search module 640, an information retrieval module 660 and an information feedback module 680.

The identifier receiving module 620 is configured to receive an information model identifier sent by a client device, where the information model identifier is sent by the client device when receiving a retrieval line which is input in a graphic manner, and then detecting that an information model matching with the retrieval line exists.

The model search module 640 is configured to identify a corresponding information model according to the information model identifier received by the identifier receiving module 620.

The information retrieval module 660 is configured to retrieve at least one piece of information matched with the information model according to the information model found out by the model search module 640.

The information feedback module 680 is configured to feed back the at least one piece of information retrieved by the information retrieval module 660 to the client device.

Further, the information retrieval module 660 includes: a parameter obtaining unit 661 and an information retrieval unit 662.

The parameter obtaining unit 661 is configured to obtain at least one condition parameter corresponding to the information model.

The information retrieval unit 662 is configured to retrieve, in all information, at least one piece of information matched with the at least one condition parameter.

Further, the server 600 further includes: a request receiving module 690 and a content feedback module 691.

The request receiving module 690 is configured to receive a detailed content obtaining request sent by the client device, where the detailed content obtaining request is a request for obtaining, after the client device presents the at least one piece of information and receives a selection signal used for selecting all or some information in the at least one piece of information, detailed content of the selected information from the server according to the selection signal.

The content feedback module 691 is configured to feed back the detailed content of the selected information to the client device.

If the information is stock information, the information model includes: at least one of a horizontal-price-movement and stock-picking model, a short-term trend rising model, a volatile and rising model, an intermediate-term trend rising model, a horizontal-price-movement and breakthrough model, a horizontal-price-movement and breakthrough adjustment model, a rising retraction model, a rising retraction breakthrough model, a rising horizontal-price-movement and consolidation model, a head-and-shoulders bottom model, a double-bottom model, a triple-bottom model, a V-shaped reversal model, an arc bottom model, a triangular consolidation model and a wedge consolidation model.

A retrieval line corresponding to the horizontal-price-movement and stock-picking model is: a line along a horizontal direction.

A retrieval line corresponding to the short-term trend rising model is: a line which extends and is formed from bottom left to top right and the length of which is less than a predetermined threshold.

A retrieval line corresponding to the volatile and rising model is: a line ascending and formed zigzag from bottom left to top right.

A retrieval line corresponding to the intermediate-term trend rising model is: a line which extends and is formed from bottom left to top right and the length of which is greater than the predetermined threshold.

A retrieval line corresponding to the horizontal-price-movement and breakthrough model is: a first line along the horizontal direction and a second line extending and formed from a right endpoint of the first line to top right.

A retrieval line corresponding to the horizontal-price-movement and breakthrough adjustment model is: a third line along the horizontal direction, a fourth line extending and formed from a right endpoint of the third line to top right and a fifth line extending and formed from a right endpoint of the fourth line to bottom right.

A retrieval line corresponding to the rising retraction model is: a sixth line extending and formed from bottom left to top right and a seventh line extending and formed from a right endpoint of the sixth line to bottom right.

A retrieval line corresponding to the rising retraction breakthrough model is: an eighth line extending and formed from bottom left to top right, a ninth line extending and formed from a right endpoint of the eighth line to bottom right and a tenth line extending and formed from a right endpoint of the ninth line to top right.

A retrieval line corresponding to the rising horizontal-price-movement and consolidation model is: an eleventh line extending and formed from bottom left to top right and a twelfth line formed along the horizontal direction from a right endpoint of the eleventh line.

A retrieval line corresponding to the head-and-shoulders bottom model is: a thirteenth line extending and formed from top left to bottom right, a fourteenth line extending and formed from a right endpoint of the thirteenth line to top right, a fifteenth line extending and formed from a right endpoint of the fourteenth line to bottom right, a sixteenth line extends forming from a right endpoint of the fifteenth line to top right, a seventeenth line extending and formed from a right endpoint of the sixteenth line to bottom right and an eighteenth line extending and formed from a right endpoint of the seventeenth line to top right, the right endpoint of the fifteenth line is lower than the right endpoint of the thirteenth line, and the right endpoint of the fifteenth line is lower than the right endpoint of the seventeenth line.

A retrieval line corresponding to the double-bottom model is: a nineteenth line extending and formed from top left to bottom right, a twentieth line extending and formed from a right endpoint of the nineteenth line to top right, a twenty first line extending and formed from a right endpoint of the twentieth line to bottom right and a twenty second line extending and formed from a right endpoint of the twenty first line to top right.

A retrieval line corresponding to the triple-bottom model is: a twenty third line extending and formed from top left to bottom right, a twenty fourth line extending and formed from a right endpoint of the twenty third line to top right, a twenty fifth line extending and formed from a right endpoint of the twenty fourth line to bottom right, a twenty sixth line extending and formed from a right endpoint of the twenty fifth line to top right, a twenty seventh line extending and formed from a right endpoint of the twenty sixth line to bottom right and a twenty eighth line extending and formed from a right endpoint of the twenty seventh line to top right.

A retrieval line corresponding to the V-shaped reversal model is: a twenty ninth line extending and formed from top left to bottom right and a thirtieth line extending and formed from a right endpoint of the twenty ninth line to top right.

A retrieval line corresponding to the arc bottom model is: a curve with an upward opening.

A retrieval line corresponding to the triangular consolidation model is: a thirty first line extending and formed from top left to bottom right and a thirty second line extending and formed from a right endpoint of the thirty first line to left below.

A retrieval line corresponding to the wedge consolidation model is: a line including two lines, slant directions of which are the same and which are not parallel.

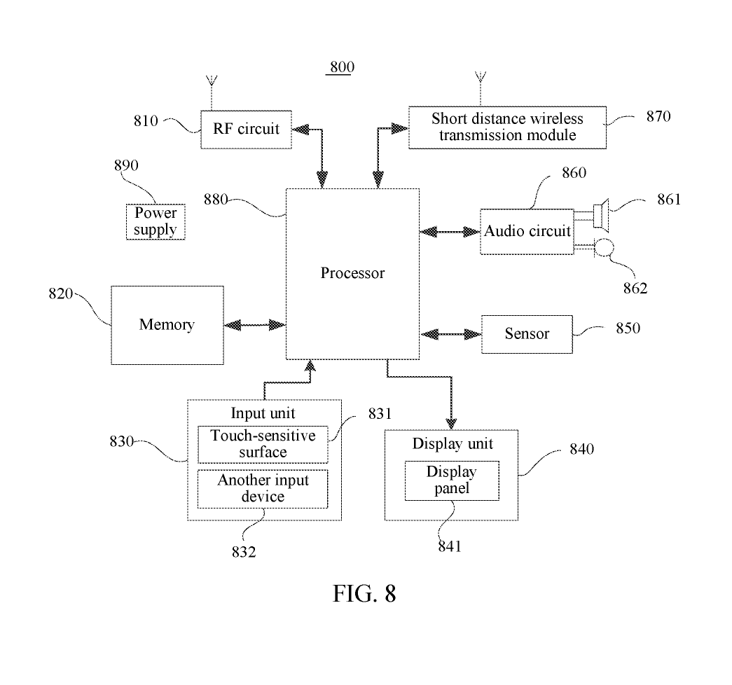

FIG. 8 is a schematic structural diagram of a terminal according to an embodiment of the present invention. Client devices such as a social client device, a payment client device, and a stock application client device are installed in the terminal 800, and the client device is configured to implement the information retrieval methods provided in the foregoing embodiments, which is specifically as follows:

The terminal 800 may include components such as a radio frequency (RF) circuit 810, a memory 820 including one or more computer readable storage media, an input unit 830, a display unit 840, a sensor 850, an audio circuit 860, a short distance wireless transmission module 870, a processor 880 including one or more processing cores, and a power supply 890. A person skilled in the art may understand that the structure of the terminal shown in FIG. 8 does not constitute a limitation to the terminal, and the terminal may include more components or fewer components than those shown in the figure, or some components may be combined, or a different component deployment may be used.

The RF circuit 810 may be configured to receive and send a signal during an information receiving and sending process or a conversation process. Specifically, the RF circuit receives downlink information from a base station, then delivers the downlink information to one or more processors 880 for processing, and sends related uplink data to the base station. Generally, the RF circuit 810 includes, but is not limited to, an antenna, at least one amplifier, a tuner, one or more oscillators, a subscriber identity module (SIM) card, a transceiver, a coupler, a low noise amplifier (LNA), and a duplexer. In addition, the RF circuit 810 may also communicate with a network and another device by wireless communication. The wireless communication may use any communications standard or protocol, which includes, but is not limited to, Global System for Mobile communications (GSM), General Packet Radio Service (GPRS), Code Division Multiple Access (CDMA), Wideband Code Division Multiple Access (WCDMA), Long Term Evolution (LTE), e-mail, Short Messaging Service (SMS), and the like. The memory 820 may be configured to store a software program and module. For example, the memory 820 may be configured to store a preset time list, may further be configured to store a software program for collecting a voice signal, a software program for implementing key word recognition, a software program for implementing consecutive voice recognition and a software program for implementing reminders setting, and may further be configured to store a binding relationship between a wireless access point and a user account, and the like. The processor 880 runs the software program and module stored in the memory 820, so as to execute various function applications and data processing, such as, a function of “receiving a retrieval line which is input in a graphic manner”, a function of “detecting whether an information model matching with the retrieval line exists” and the like in the embodiments of the present invention. The memory 820 may mainly include a program storage area and a data storage area. The program storage area may store an operating system, an application program required by at least one function (such as a sound playback function and an image display function), and the like. The data storage area may store data (such as audio data and an address book) created according to use of the terminal 800, and the like. In addition, the memory 820 may include a high speed random access memory, and may also include a non-volatile memory, such as at least one magnetic disk storage device, a flash memory, or another volatile solid storage device. Accordingly, the memory 820 may further include a memory controller, so that the processor 880 and the input unit 830 access the memory 820.

The input unit 830 may be configured to receive input digit or character information, and generate keyboard, mouse, joystick, optical, or track ball signal input related to the user setting and function control. Specifically, the input unit 830 may include a touch-sensitive surface 831 and another input device 832. The touch-sensitive surface 831 may also be referred to as a touch screen or a touch panel, and may collect a touch operation of a user on or near the touch-sensitive surface (such as an operation of a user on or near the touch-sensitive surface 831 by using any suitable object or attachment, such as a finger or a touch pen), and drive a corresponding connection apparatus according to a preset program. Optionally, the touch-sensitive surface 831 may include two parts: a touch detection apparatus and a touch controller. The touch detection apparatus detects a touch position of the user, detects a signal generated by the touch operation, and transfers the signal to the touch controller. The touch controller receives the touch information from the touch detection apparatus, converts the touch information into touch point coordinates, and sends the touch point coordinates to the processor 880. Moreover, the touch controller can receive and execute a command sent from the processor 880. In addition, the touch-sensitive surface 831 may be implemented by using various types, such as a resistive type, a capacitance type, an infrared type, and a surface sound wave type. In addition to the touch-sensitive surface 831, the input unit 830 may further include the another input device 832. Specifically, the another input device 832 may include, but is not limited to, one or more of a physical keyboard, a functional key (such as a volume control key or a switch key), a track ball, a mouse, and a joystick.

The display unit 840 may be configured to display information input by the user or information provided for the user, and various graphical user ports of the terminal 800. The graphical user ports may be formed by a graph, a text, an icon, a video, and any combination thereof. The display unit 840 may include a display panel 841. Optionally, the display panel 841 may be configured by using a liquid crystal display (LCD), an organic light-emitting diode (OLED), or the like. Further, the touch-sensitive surface 831 may cover the display panel 841. After detecting a touch operation on or near the touch-sensitive surface 831, the touch-sensitive surface 831 transfers the touch operation to the processor 880, so as to determine a type of a touch event. Then, the processor 880 provides corresponding visual output on the display panel 841 according to the type of the touch event. Although, in FIG. 8, the touch-sensitive surface 831 and the display panel 841 are used as two separate parts to implement input and output functions, in some embodiments, the touch-sensitive surface 831 and the display panel 841 may be integrated to implement the input and output functions.

The terminal 800 may further include at least one sensor 850, such as an optical sensor, a motion sensor, and other sensors. Specifically, the optical sensor may include an ambient light sensor and a proximity sensor. The ambient light sensor may adjust luminance of the display panel 841 according to brightness of the ambient light. The proximity sensor may switch off the display panel 841 and/or backlight when the terminal 800 is moved to the ear. As one type of motion sensor, a gravity acceleration sensor may detect magnitude of accelerations at various directions (which generally are triaxial), may detect magnitude and a direction of the gravity when static, and may be configured to identify an application of a mobile phone gesture (such as switchover between horizontal and vertical screens, a related game, and gesture calibration of a magnetometer), a related function of vibration identification (such as a pedometer and a knock). Other sensor, such as a gyroscope, a barometer, a hygrometer, a thermometer, and an infrared sensor, which may be configured in the terminal 800 are not further described herein.

The audio circuit 860, a loudspeaker 861, and a microphone 862 may provide audio interfaces between the user and the terminal 800. The audio circuit 860 may transmit, to the loudspeaker 861, a received electric signal converted from received audio data. The loudspeaker 861 converts the electric signal into a sound signal for output. On the other hand, the microphone 862 converts a collected sound signal into an electric signal. The audio circuit 860 receives the electric signal and converts the electric signal into audio data, and outputs the audio data to the processor 880 for processing. Then, the processor 880 sends the audio data to another terminal by using the RF circuit 810, or outputs the audio data to the memory 820 for further processing. The audio circuit 860 may further include an earplug jack, so as to provide communication between a peripheral earphone and the terminal 800.

The short distance wireless transmission module 870 may be a wireless fidelity (WIFI) module, a Bluetooth module or the like. The terminal 800 may help, by using the short distance wireless transmission module 870, a user to receive and send an e-mail, browse a webpage, and access stream media, and the like, which provides wireless broadband Internet access for the user. Although FIG. 8 shows short distance wireless transmission module 870, it may be understood that, the wireless communications unit does not belong to a necessary constitution of the terminal 800, and can be ignored according to demands without changing the scope of the essence of the present disclosure.

The processor 880 is a control center of the terminal 800, and connects to various parts of the terminal by using various interfaces and lines. By running or executing the software program and/or module stored in the memory 820, and invoking data stored in the memory 820, the processor 880 performs various functions and data processing of the terminal 800, thereby performing overall monitoring on the terminal. Optionally, the processor 880 may include one or more processing cores. Optionally, the processor 880 may integrate an application processor and a modem. The application processor mainly processes an operating system, a user interface, an application program, and the like. The modem mainly processes wireless communication. It may be understood that, the foregoing modem may also not be integrated into the processor 880.

The terminal 800 further includes the power supply 890 (such as a battery) for supplying power to the components. Preferably, the power supply may logically connect to the processor 880 by using a power supply management system, thereby implementing functions, such as charging, discharging, and power consumption management, by using the power supply management system. The power supply 890 may further include any component, such as one or more direct current or alternate current power supplies, a re-charging system, a power supply fault detection circuit, a power supply converter or an inverter, and a power supply state indicator.

Although not shown in the figure, the terminal 800 may further include a camera, a Bluetooth module, and the like, which are not further described herein.

The terminal 800 further includes a memory and one or more programs. The one or more programs are stored in the memory and configured to execute the information retrieval method of the embodiment in FIG. 2 or FIG. 4A by means of one or more processors.

It should be additionally noted that in another embodiment, the terminal may include more components or fewer components than those shown in FIG. 8, or some components may be combined, or a different component deployment may be used, to implement all or some functions.

Moreover, the method according to the present disclosure may further be implemented into a computer program executed by a CPU, and the computer program may be stored in a computer readable storage medium. When the computer program is executed by the CPU, the foregoing functions limited in the method of the present disclosure are executed.

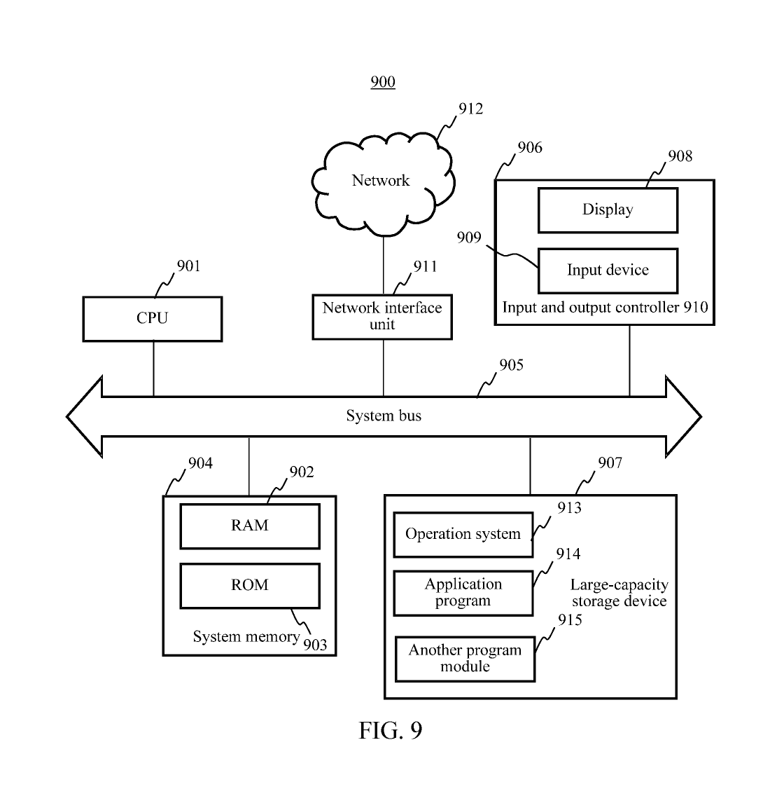

FIG. 9 is a schematic structural diagram of a server according to an embodiment of the present invention. The server is configured to implement the information retrieval methods provided in the foregoing embodiments, which is specifically as follows.

The server 900 includes a central processing unit (CPU) 901, a system memory 904 including a random access memory (RAM) 902 and a read only memory (ROM) 903, and a system bus 905 connecting the system memory 904 and the CPU 901. The server 900 further includes a basic input/output system (I/O system) 906 assisting in transmitting information between devices in a computer, and a large-capacity storage device 907 configured to store an operating system 913, an application program 914 and another program module 915.

The basic I/O system 906 includes a display 908 configured to display information and an input device 909, such as a mouse or a keyboard, configured to input information for a user. The display 908 and the input device 909 are both connected to the CPU 901 by using an input and output controller 910 connected to the system bus 905. The basic I/O system 906 may further include the input and output controller 910 to be configured to receive and process inputs from multiple other devices such as a keyboard, a mouse, and an electronic stylus. Similarly, the input and output controller 910 further provides an output to a display screen, a printer or another type of output device.

The large-capacity storage device 907 is connected to the CPU 901 by using a large-capacity storage controller (not shown) connected to the system bus 905. The large-capacity storage device 907 and its associated computer readable medium provide non-volatile storage for the client device. That is to say, the large-capacity storage device 907 may include the computer readable medium (not shown) such as a hard disk or a CD-ROM driver.

Without loss of generality, the computer readable medium may include a computer storage medium and a communications medium. The computer storage medium includes volatile and non-volatile media, and removable and non-removable media implemented by using any method or technology used for storing information such as a computer readable instruction, a data structure, a program module or other data. The computer storage medium includes a RAM, a ROM, an EPROM, an EEPROM, a flash memory or other solid storage technologies; a CD-ROM, a DVD or other optical storages; and a cassette, a magnetic tape, a disk storage or other magnetic storage devices. Certainly, persons skilled in art can know that the computer storage medium is not limited to the foregoing several types. The system memory 904 and the large-capacity storage device 907 may be collectively referred to as a memory.

According to various embodiments of the present invention, the server 900 may further be connected, by using a network such as the Internet, to a remote computer on the network and run. That is, the server 900 may be connected to a network 912 by using a network interface unit 911 connected to the system bus 905, or may also be to connected to another type of network or remote computer system (not shown) by using the network interface unit 911.

The memory further includes one or more programs, the one or more programs are stored in the memory, and are configured to execute, by using one or more CPUs 901, the one or more programs, which includes executing the information retrieval method provided in the embodiment shown in FIG. 3 or FIG. 4A.

The sequence numbers of the foregoing embodiments of the present invention are merely for the convenience of description, and do not imply the preference among the embodiments.

A person of ordinary skill in the art may understand that all or some of the steps of the foregoing embodiments may be implemented by using hardware, or may be implemented by a program instructing relevant hardware. The program may be stored in a computer readable storage medium. The storage medium may be a read-only memory, a magnetic disk, an optical disc, or the like.

The foregoing descriptions are merely preferred embodiments of the present invention, but are not intended to limit the present disclosure. Any modification, equivalent replacement, or improvement made within the spirit and principle of the present disclosure shall fall within the protection scope of the present disclosure.

What is claimed is:

1. An information retrieval method applied to a client device having one or more processors and a memory for storing instructions executed by the one or more processors, the method comprising:
receiving a retrieval line which is input in a graphic manner;
detecting whether an information model matching with the retrieval line exists, each information model corresponding to an information model identifier;
sending, if a detection result is that an information model matching with the retrieval line exists, an information model identifier of the information model to a server; and
receiving at least one piece of information fed back by the server, the information being fed back after the server identifies a corresponding information model according to the information model identifier and then retrieves at least one piece of information matching with the information model according to the information model.

2. The method according to claim 1, wherein the receiving a retrieval line which is input in a graphic manner comprises:
receiving the retrieval line which is input by means of a slide touch signal.

3. The method according to claim 1, wherein the receiving a retrieval line which is input in a graphic manner comprises:
receiving the retrieval line which is input by means of a mouse drag signal.

4. The method according to claim 1, wherein the detecting whether an information model matching with the retrieval line exists comprises:
searching for an information model matching with a line characteristic of the retrieval line according to the line characteristic of the retrieval line.

5. The method according to claim 4, wherein if the information is stock information, the searching for an information model matching with a line characteristic of the retrieval line according to the line characteristic of the retrieval line comprises:
determining, when the retrieval line is a line along a horizontal direction, whether the information model matched with the line characteristic of the retrieval line is a horizontal-price-movement and stock-picking model.

6. The method according to claim 4, wherein if the information is stock information, the searching for an information model matching with a line characteristic of the retrieval line according to the line characteristic of the retrieval line comprises:
determining, when the retrieval line is a line which extends and is formed from bottom left to top right and the length of which is less than a predetermined threshold, whether the information model matched with the line characteristic of the retrieval line is a short-term trend rising model.

7. The method according to claim 4, wherein if the information is stock information, the searching for an information model matching with a line characteristic of the retrieval line according to the line characteristic of the retrieval line comprises:
determining, when the retrieval line is a line ascending and formed zigzag from bottom left to top right, whether the information model matched with the line characteristic of the retrieval line is a volatile and rising model.

8. The method according to claim 4, wherein if the information is stock information, the searching for an information model matching with a line characteristic of the retrieval line according to the line characteristic of the retrieval line comprises:
determining, when the retrieval line is a line which extends and is formed from bottom left to top right and the length of which is greater than the predetermined threshold, whether the information model matched with the line characteristic of the retrieval line is an intermediate-term trend rising model.

9. The method according to claim 4, wherein if the information is stock information, the searching for an information model matching with a line characteristic of the retrieval line according to the line characteristic of the retrieval line comprises:
determining, when the retrieval line is a first line along the horizontal direction and a second line extending and formed from a right endpoint of the first line to top right, whether the information model matched with the line characteristic of the retrieval line is a horizontal-price-movement and breakthrough model.

10. The method according to claim 4, wherein if the information is stock information, the searching for an information model matching with a line characteristic of the retrieval line according to the line characteristic of the retrieval line comprises:
determining, when the retrieval line is a third line along the horizontal direction, a fourth line extending and formed from a right endpoint of the third line to top right and a fifth line extending and formed from a right endpoint of the fourth line to bottom right, whether the information model matched with the line characteristic of the retrieval line is a horizontal-price-movement and breakthrough adjustment model.

11. The method according to claim 4, wherein if the information is stock information, the searching for an information model matching with a line characteristic of the retrieval line according to the line characteristic of the retrieval line comprises:
determining, when the retrieval line is a sixth line extending and formed from bottom left to top right and a seventh line extending and formed from a right endpoint of the sixth line to bottom right, whether the information model matched with the line characteristic of the retrieval line is a rising retraction model.

12. The method according to claim 4, wherein if the information is stock information, the searching for an information model matching with a line characteristic of the retrieval line according to the line characteristic of the retrieval line comprises:
determining, when the retrieval line is an eighth line extending and formed from bottom left to top right, a ninth line extending and formed from a right endpoint of the eighth line to bottom right and a tenth line extending and formed from a right endpoint of the ninth line to top right, whether the information model matched with the line characteristic of the retrieval line is a rising retraction breakthrough model.

13. The method according to claim 4, wherein if the information is stock information, the searching for an information model matching with a line characteristic of the retrieval line according to the line characteristic of the retrieval line comprises:
determining, when the retrieval line is an eleventh line extending and formed from bottom left to top right and a twelfth line formed along the horizontal direction from a right endpoint of the eleventh line, whether the information model matched with the line characteristic of the retrieval line is a rising horizontal-price-movement and consolidation model.

14. The method according to claim 4, wherein if the information is stock information, the searching for an information model matching with a line characteristic of the retrieval line according to the line characteristic of the retrieval line comprises:
determining, when the retrieval line is a thirteenth line extending and formed from top left to bottom right, a fourteenth line extending and formed from a right endpoint of the thirteenth line to top right, a fifteenth line extending and formed from a right endpoint of the fourteenth line to bottom right, a sixteenth line extends forming from a right endpoint of the fifteenth line to top right, a seventeenth line extending and formed from a right endpoint of the sixteenth line to bottom right and an eighteenth line extending and formed from a right endpoint of the seventeenth line to top right, the right endpoint of the fifteenth line is lower than the right endpoint of the thirteenth line, and the right endpoint of the fifteenth line is lower than the right endpoint of the seventeenth line, whether the information model matched with the line characteristic of the retrieval line is a head-and-shoulders bottom model.

15. The method according to claim 4, wherein if the information is stock information, the searching for an information model matching with a line characteristic of the retrieval line according to the line characteristic of the retrieval line comprises:
determining, when the retrieval line is a nineteenth line extending and formed from top left to bottom right, a twentieth line extending and formed from a right endpoint of the nineteenth line to top right, a twenty first line extending and formed from a right endpoint of the twentieth line to bottom right and a twenty second line extending and formed from a right endpoint of the twenty first line to top right, whether the information model matched with the line characteristic of the retrieval line is a double-bottom model.

16. The method according to claim 4, wherein if the information is stock information, the searching for an information model matching with a line characteristic of the retrieval line according to the line characteristic of the retrieval line comprises:
determining, when the retrieval line is a twenty third line extending and formed from top left to bottom right, a twenty fourth line extending and formed from a right endpoint of the twenty third line to top right, a twenty fifth line extending and formed from a right endpoint of the twenty fourth line to bottom right, a twenty sixth line extending and formed from a right endpoint of the twenty fifth line to top right, a twenty seventh line extending and formed from a right endpoint of the twenty sixth line to bottom right and a twenty eighth line extending and formed from a right endpoint of the twenty seventh line to top right, whether the information model matched with the line characteristic of the retrieval line is a triple-bottom model.

17. The method according to claim 4, wherein if the information is stock information, the searching for an information model matching with a line characteristic of the retrieval line according to the line characteristic of the retrieval line comprises:
determining, when the retrieval line is a twenty ninth line extending and formed from top left to bottom right and a thirtieth line extending and formed from a right endpoint of the twenty ninth line to top right, whether the information model matched with the line characteristic of the retrieval line is a V-shaped reversal model.

18. The method according to claim 4, wherein if the information is stock information, the searching for an information model matching with a line characteristic of the retrieval line according to the line characteristic of the retrieval line comprises:
determining, when the retrieval line is a curve with an upward opening, whether the information model matched with the line characteristic of the retrieval line is an arc bottom model.

19. The method according to claim 4, wherein if the information is stock information, the searching for an information model matching with a line characteristic of the retrieval line according to the line characteristic of the retrieval line comprises:
determining, when the retrieval line is a thirty first line extending and formed from top left to bottom right and a thirty second line extending and formed from a right endpoint of the thirty first line to left below, whether the information model matched with the line characteristic of the retrieval line is a triangular consolidation model.

20. The method according to claim 4, wherein if the information is stock information, the searching for an information model matching with a line characteristic of the retrieval line according to the line characteristic of the retrieval line comprises:
determining, when the retrieval line is a line comprising two lines, slant directions of which are the same and which are not parallel, whether the information model matched with the line characteristic of the retrieval line is a wedge consolidation model.

21. The method according to claim 1, after the receiving at least one piece of information fed back by the server, further comprising:
presenting the at least one piece of information;
receiving a selection signal used for selecting all or some information in the at least one piece of information;
sending a detailed content obtaining request to the server according to the selection signal, wherein the detailed content obtaining request is used for obtaining detailed content of the selected information; and
receiving and presenting the detailed content of the information fed back by the server.

22. The method according to claim 1, after the receiving at least one piece of information fed back by the server, further comprising:
receiving a saving signal used for saving all or some information in the at least one piece of information; and
saving the selected information into an information pool, wherein the information in the information pool is used for being automatically presented in a subsequent retrieval process.

23. An information retrieval method applied to a server having one or more processors and a memory for storing instructions executed by the one or more processors, the method comprising:
receiving an information model identifier sent by a client device, the information model identifier being sent by the client device when receiving a retrieval line which is input in a graphic manner, and then detecting that an information model matching with the retrieval line exists;
identifying a corresponding information model according to the information model identifier;
retrieving at least one piece of information matched with the information model according to the information model; and
feeding back the at least one piece of information to the client device.

24. The method according to claim 23, wherein the retrieving at least one piece of information matched with the information model according to the information model comprises:
obtaining at least one condition parameter corresponding to the information model; and
retrieving, in all information, at least one piece of information matched with the at least one condition parameter.

25. The method according to claim 23, after the feeding back the at least one piece of information to the client device, further comprising:
receiving a detailed content obtaining request sent by the client device, wherein the detailed content obtaining request is a request for obtaining, after the client device presents the at least one piece of information and receives a selection signal used for selecting all or some information in the at least one piece of information, detailed content of the selected information from the server according to the selection signal; and
feeding back the detailed content of the selected information to the client device.

26. The method according to claim 25, wherein if the information is stock information, the information model comprises: at least one of a horizontal-price-movement and stock-picking model, a short-term trend rising model, a volatile and rising model, an intermediate-term trend rising model, a horizontal-price-movement and breakthrough model, a horizontal-price-movement and breakthrough adjustment model, a rising retraction model, a rising retraction breakthrough model, a rising horizontal-price-movement and consolidation model, a head-and-shoulders bottom model, a double-bottom model, a triple-bottom model, a V-shaped reversal model, an arc bottom model, a triangular consolidation model and a wedge consolidation model;
a retrieval line corresponding to the horizontal-price-movement and stock-picking model is: a line along a horizontal direction;
a retrieval line corresponding to the short-term trend rising model is: a line which extends and is formed from bottom left to top right and the length of which is less than a predetermined threshold;
a retrieval line corresponding to the volatile and rising model is: a line ascending and formed zigzag from bottom left to top right;
a retrieval line corresponding to the intermediate-term trend rising model is: a line which extends and is formed from bottom left to top right and the length of which is greater than the predetermined threshold;
a retrieval line corresponding to the horizontal-price-movement and breakthrough model is: a first line along the horizontal direction and a second line extending and formed from a right endpoint of the first line to top right;
a retrieval line corresponding to the horizontal-price-movement and breakthrough adjustment model is: a third line along the horizontal direction, a fourth line extending and formed from a right endpoint of the third line to top right and a fifth line extending and formed from a right endpoint of the fourth line to bottom right;
a retrieval line corresponding to the rising retraction model is: a sixth line extending and formed from bottom left to top right and a seventh line extending and formed from a right endpoint of the sixth line to bottom right;
a retrieval line corresponding to the rising retraction breakthrough model is: an eighth line extending and formed from bottom left to top right, a ninth line extending and formed from a right endpoint of the eighth line to bottom right and a tenth line extending and formed from a right endpoint of the ninth line to top right;
a retrieval line corresponding to the rising horizontal-price-movement and consolidation model is: an eleventh line extending and formed from bottom left to top right and a twelfth line formed along the horizontal direction from a right endpoint of the eleventh line;
a retrieval line corresponding to the head-and-shoulders bottom model is: a thirteenth line extending and formed from top left to bottom right, a fourteenth line extending and formed from a right endpoint of the thirteenth line to top right, a fifteenth line extending and formed from a right endpoint of the fourteenth line to bottom right, a sixteenth line extends forming from a right endpoint of the fifteenth line to top right, a seventeenth line extending and formed from a right endpoint of the sixteenth line to bottom right and an eighteenth line extending and formed from a right endpoint of the seventeenth line to top right, the right endpoint of the fifteenth line is lower than the right endpoint of the thirteenth line, and the right endpoint of the fifteenth line is lower than the right endpoint of the seventeenth line;
a retrieval line corresponding to the double-bottom model is: a nineteenth line extending and formed from top left to bottom right, a twentieth line extending and formed from a right endpoint of the nineteenth line to top right, a twenty first line extending and formed from a right endpoint of the twentieth line to bottom right and a twenty second line extending and formed from a right endpoint of the twenty first line to top right;
a retrieval line corresponding to the triple-bottom model is: a twenty third line extending and formed from top left to bottom right, a twenty fourth line extending and formed from a right endpoint of the twenty third line to top right, a twenty fifth line extending and formed from a right endpoint of the twenty fourth line to bottom right, a twenty sixth line extending and formed from a right endpoint of the twenty fifth line to top right, a twenty seventh line extending and formed from a right endpoint of the twenty sixth line to bottom right and a twenty eighth line extending and formed from a right endpoint of the twenty seventh line to top right;
a retrieval line corresponding to the V-shaped reversal model is: a twenty ninth line extending and formed from top left to bottom right and a thirtieth line extending and formed from a right endpoint of the twenty ninth line to top right;
a retrieval line corresponding to the arc bottom model is: a curve with an upward opening;
a retrieval line corresponding to the triangular consolidation model is: a thirty first line extending and formed from top left to bottom right and a thirty second line extending and formed from a right endpoint of the thirty first line to left below; and
a retrieval line corresponding to the wedge consolidation model is: a line comprising two lines, slant directions of which are the same and which are not parallel.

27. An information retrieval apparatus, comprising:
one or more processors; and
a memory,
wherein one or more program modules are stored in the memory and executed by the one or more processors, and the one or more program modules comprise:
a line receiving module, configured to receive a retrieval line which is input in a graphic manner;
a line detecting module, configured to detect whether an information model matching with the retrieval line exists, each information model corresponding to an information model identifier;
an identifier sending module, configured to send, if a detection result is that an information model matching with the retrieval line exists, an information model identifier of the information model to a server; and
an information receiving module, configured to receive at least one piece of information fed back by the server, the information being fed back after the server identifies a corresponding information model according to the information model identifier and then retrieves at least one piece of information matched with the information model according to the information model.

28. An information retrieval apparatus, comprising: one or more processors; and a memory, wherein one or more program modules are stored in the memory and executed by the one or more processors, and the one or more program modules comprise:
an identifier receiving module, configured to receive an information model identifier sent by a client device, wherein the information model identifier is sent by the client device when receiving a retrieval line which is input in a graphic manner, and then detecting that an information model matching with the retrieval line exists;
a model search module, configured to identify a corresponding information model according to the information model identifier;
an information retrieval module, configured to retrieve at least one piece of information matching with the information model according to the information model; and
an information feedback module, configured to feed back the at least one piece of information to the client device.
